(19) United States
(12) Patent Application Publication
(10) Pub. No.: US 2017/0341529 A1
(43) Pub. Date: Nov. 30, 2017

(54) VEHICLE SEAT ADJUSTMENT DEVICE AND VEHICLE SEAT ADJUSTMENT METHOD

(71) Applicant: TOYOTA BOSHOKU KABUSHIKI KAISHA, Aichi-ken (JP)

(72) Inventors: Haruki UNO, Aichi-ken (JP); Takuya FUJIMURA, Aichi-ken (JP)

(73) Assignee: TOYOTA BOSHOKU KABUSHIKI KAISHA, Aichi-ken (JP)

(21) Appl. No.: 15/604,763

(22) Filed: May 25, 2017

(30) Foreign Application Priority Data
May 27, 2016 (JP) 2016-106358

(51) Int. Cl. B60N 2/02; B60N 2/01; B60N 2/22

(52) U.S. Cl. CPC B60N 2/0244; B60N 2/22; B60N 2/01; B60N 2002/0272

(57) ABSTRACT

A vehicle seat adjustment device mounted on a vehicle in which a plurality of seats including a last-row seat in a last row and a second-to-last-row seat in a second-to-last row is arranged in a front and rear direction and configured to adjust states of the last-row seat and the second-to-last-row seat. When respectively shifting the last-row seat and the second-to-last-row seat to their accommodation states by operating an operation part, the first drive part and the second drive part are controlled so that there is a period during which a seat back of the last-row seat and a seat back of the second-to-last-row seat are simultaneously rotated forward.

### CROSS-REFERENCE TO RELATED APPLICATIONS

This application claims priority from Japanese Patent Application No. 2016-106358 filed on May 27, 2016, the entire contents of which are incorporated herein by reference.

### TECHNICAL FIELD

The disclosure relates to a technique for adjusting states of a seat in a first row and a seat in a second-to-last row in a vehicle in which a plurality of seats is arranged in a front and rear direction.

### BACKGROUND

Recently, three-row seat type vehicles in which three rows of seats are arranged in a front and rear direction are in widespread use mainly in relatively large type passenger cars such as minivans or SUVs (e.g., see JP-A-2006-96303).

Further, there is provided a three-row seat type passenger car in which a state and position of each seat can be variously arranged to be able to effectively utilize a passenger compartment as necessary.

As a method of arranging respective seats in a three-row seat type vehicle, there is a method where a seat back of a seat in a last row and a seat back of a seat in a second-to-last row are respectively tilted toward the front to the maximum. When the seat backs of respective seats in the last row and the second-to-last row can be respectively tilted toward the front to the maximum, a luggage loading space that is long in the front and rear direction can be provided at an upper space of each seat. In this way, long luggage or large luggage can be conveniently loaded thereon.

Not only in the three-row seat type vehicle but also in a two-row seat type vehicle or a four-row or more seat type vehicle, the space in a passenger compartment can be effectively and conveniently utilized when the seat backs of respective seats in the last row and the second-to-last row can be respectively tilted toward the front.

However, in a case where it is desired to tilt, toward the front, all of the seat backs of respective seats in the last row and the second-to-last row for the purpose of providing a luggage loading space that is long in the front and rear direction or for other purposes, it is inconvenient for a user to separately manipulate respective seats to be tilted toward the front. Also, it takes time to tilt both of the seats in the last row and the second-to-last row.

### SUMMARY

The disclosure aims to improve the usability of a user when tilting, toward the front, both of the seat backs of the respective seats in the last row and the second-to-last row in a vehicle in which a plurality of seats is arranged in the front and rear direction.

According to an aspect of the disclosure, there is provided a vehicle seat adjustment device mounted on a vehicle in which a plurality of seats including a last-row seat in a last row and a second-to-last-row seat in a second-to-last row is arranged in a front and rear direction and configured to adjust states of the last-row seat and the second-to-last-row seat, the vehicle seat adjustment device including: a first drive part configured to rotate a seat back of the last-row seat relative to a seat cushion of the last-row seat; a second drive part configured to rotate a seat back of the second-to-last-row seat relative to a seat cushion of the second-to-last-row seat; an operation part configured to be operated by a user; and an accommodation control part configured to, in a case where the operation part is operated, shift the last-row seat to an accommodation state in which the seat back of the last-row seat is rotated forward and folded down by driving the first drive part to thus rotate the seat back of the last-row seat forward, and shift the second-to-last-row seat to an accommodation state in which the seat back of the second-to-last-row seat is rotated forward and folded down by driving the second drive part to thus rotate the seat back of the second-to-last-row seat forward, wherein, when respectively shifting the last-row seat and the second-to-last-row seat to their accommodation states by operating the operation part, the accommodation control part is configured to control the first drive part and the second drive part so that there is a period during which the seat back of the last-row seat and the seat back of the second-to-last-row seat are simultaneously rotated forward.

According to the vehicle seat adjustment device having such a configuration, both the last-row seat and the second-to-last-row seat can be shifted to their accommodation states by a user operating the operation part. In addition, in the course of shifting the last-row seat and the second-to-last-row seat to their accommodation states, there is a period during which the seat back of the last-row seat and the seat back of the second-to-last-row seat are simultaneously rotated forward. Therefore, it is possible to shorten the time required for shifting both seats to their accommodation states, as compared with a method of sequentially shifting the last-row seat and the second-to-last-row seat to their accommodation states, i.e., the method of first shifting only one of the last-row seat and the second-to-last-row seat to the accommodation state, and then, shifting the other of the last-row seat and the second-to-last-row seat to the accommodation state, for example.

Thus, according to the vehicle seat adjustment device having such a configuration, it is possible to improve the usability of a user when tilting, toward the front, both of the seat backs of the respective seats in the last row and the second-to-last row in the vehicle in which a plurality of seats is arranged in the front and rear direction.

According to another aspect of the disclosure, there is provided a vehicle seat adjustment method for a vehicle in which a plurality of seats including a last-row seat in a last row and a second-to-last-row seat in a second-to-last row is arranged in a front and rear direction, the vehicle seat adjustment method including: operating an operation part; and in a case where the operation part is operated, shifting the last-row seat to an accommodation state in which a seat back of the last-row seat is rotated forward and folded down by rotating the seat back of the last-row seat forward, and shifting the second-to-last-row seat to an accommodation state in which a seat back of the second-to-last-row seat is rotated forward and folded down by rotating the seat back of the second-to-last-row seat forward, wherein, when respectively shifting the last-row seat and the second-to-last-row seat to their accommodation states, there is a period during which the seat back of the last-row seat and the seat back of the second-to-last-row seat are simultaneously rotated forward.

Meanwhile, in the description in this section, the seat in the last row is referred to as the “last-row seat,” and the seat in the second-to-last row is referred to as the “second-to-last-row seats.” However, these may be expressed in a different manner. For example, the seat in the second-to-last row may be referred to as the “first seat,” and the seat in the last row may be referred to as the “second seat.” Further, for example, the seat in the second-to-last row may be referred to as the “first rear seat,” and the seat in the last row may be referred to as the “second rear seat” Further, for example, the seat in the second-to-last row may be referred to as the “front-side seat.” and the seat in the last row may be referred to as the “rear-side seat.”

### BRIEF DESCRIPTION OF DRAWINGS

FIG. 1 is an explanatory diagram briefly showing an overall configuration of a vehicle according to an embodiment;

FIG. 2 is an explanatory diagram for explaining a range in which a second seat back and a third seat back according to the embodiment can be rotated;

FIG. 3 is a block diagram showing an electrical configuration of a seat adjustment device according to the embodiment;

FIG. 4 is an explanatory diagram showing an example of a positional relationship between the second seat back and the third seat back in a process in which both seat backs are simultaneously accommodated in a first embodiment;

FIGS. 5A to 5C are explanatory diagrams showing an example of a state change of each seat back in the process in which the second seat back and the third seat back are simultaneously accommodated in the first embodiment;

FIG. 6 is a flow chart of a simultaneous control processing in the first embodiment;

FIG. 7 is an explanatory diagram showing an example of a positional relationship between the second seat back and the third seat back in a process in which both seat backs are simultaneously accommodated in a second embodiment;

FIG. 8 is an explanatory diagram showing another example of a positional relationship between the second seat back and the third seat back in a process in which both seat backs are simultaneously accommodated in the second embodiment; and

FIG. 9 is a flow chart of a simultaneous control processing in the second embodiment.

### DETAILED DESCRIPTION

Hereinafter, exemplary embodiments of the disclosure will be described with reference to the drawings.

### First Embodiment

(1) Overall Configuration of Vehicle

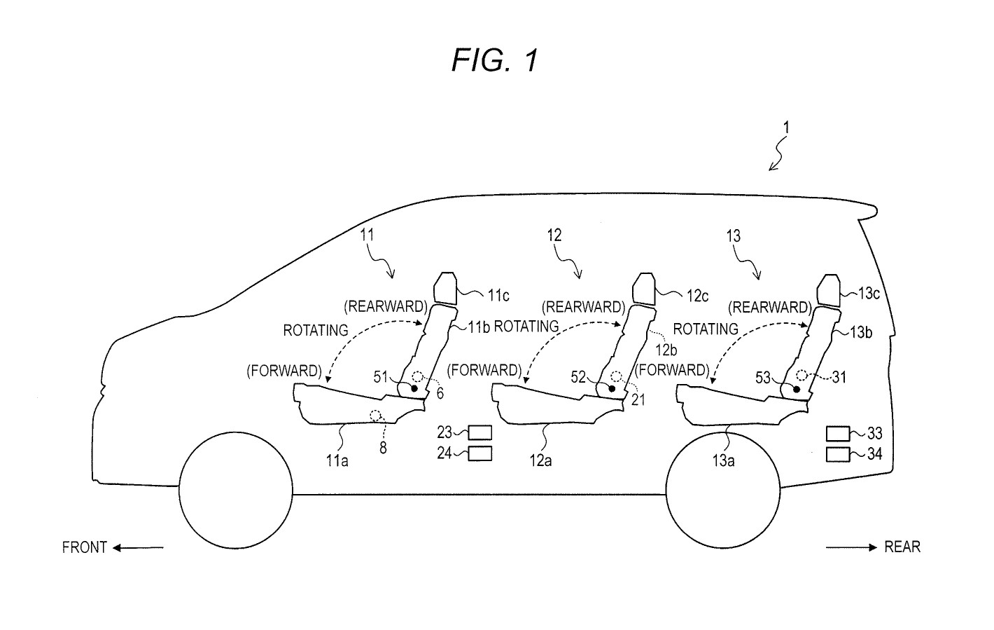

As shown in FIG. 1, a vehicle 1 is a three-row seat type vehicle in which three rows of seats are arranged in a front and rear direction. That is, a front seat 11 that is a seat in a first row, a second seat 12 that is a seat in a second row, and a third seat 13 that is a seat in a third row are arranged in this order from the front to the rear of the vehicle.

The front seat 11 includes a seat cushion 11a for supporting a hip of an occupant, and a seat back 11b for supporting a back of the occupant. A headrest 11c for supporting a head of the occupant is attached to an upper portion of the seat back 11b.

Similarly, the second seat 12 includes a seat cushion 12a and a seat back 12b, and a headrest 12c is attached to an upper portion of the seat back 12b. Further, the third seat 13 includes a seat cushion 13a and a seat back 13b, and a headrest 13c is attached to an upper portion of the seat back 13b.

A front reclining motor 6 and a slide motor 8 are provided in the front seat 11. A seat back (hereinafter, referred to as a “front seat back”) 11b of the front seat 11 is configured to be rotatable in a direction indicated by a broken line arrow in FIG. 1 with a rotating shaft 51 as an axis by using the front reclining motor 6 as a driving source. Further the front seat 11 is configured to be movable (slidable) in the front and rear direction by using the slide motor 8 as a driving source.

Meanwhile, in the present specification, regarding the rotating direction of the seat back, “the front” and “the rear” are defined as indicated by the broken line arrow in FIG. 1. That is, the rotating of the seat back toward “the front” means that the seat back is being tilted toward a vehicle front (and thus, the surface of the seat back approaches the surface of the seat cushion). On the contrary, the rotating of the seat back toward “the rear” means that the seat back is being tilted toward a vehicle rear (and thus, the surface of the seat back moves away from the surface of the seat cushion and thus the seat back approaches the rear seat side).

A second reclining motor 21 is provided in the second seat 12. A seat back (hereinafter, referred to as a “second seat back”) 12b of the second seat 12 is configured to be rotatable in the direction indicated by the broken line arrow in FIG. 1 with a rotating shaft 52 as an axis by using the second reclining motor 21 as a driving source.

A third reclining motor 31 is provided in the third seat 13. A seat back (hereinafter, referred to as a “third seat back”) 13b of the third seat 13 is configured to be rotatable in the direction indicated by the broken line arrow in FIG. 1 with a rotating shaft 53 as an axis by using the third reclining motor 31 as a driving source.

Meanwhile, in the vehicle 1, two doors (a front door and a rear door) for getting on and off are provided respectively in the front and rear direction on both sides of a vehicle body. A passenger can sit on the front seat 11 by opening the front door and sit on the second seat 12 by opening the rear door. Further, a passenger can enter a rear part of the second seat 12 from the rear door and sit on the third seat 13 by opening the rear door and tilting the second seat back 12b forward. Further, a luggage compartment door for loading and unloading luggage is provided on the rear side of the vehicle 1. By opening the luggage compartment door, the loading and unloading of the luggage from the rear side of the vehicle 1 into a passenger compartment can be performed.

Further, as a switch to be operated by a user such as a driver or other passengers, a first simultaneously accommodating switch 23, a first simultaneously returning switch 24, a second simultaneously accommodating switch 33, and a second simultaneously returning switch 34 are provided in the vehicle 1. Meanwhile, in the present embodiment, all of these switches are push-button type switches. These switches are turned on when a pushing operation is performed and are turned off when the pushing operation is released.

The first simultaneously accommodating switch 23 and the first simultaneously returning switch 24 are provided, for example, in the second seat 12 or in the vicinity thereof such as the rear door, and are disposed so as to be operated from the rear door side (i.e., from a vehicle side) by opening the rear door. The second simultaneously accommodating switch 33 and the second simultaneously returning switch 34 are provided, for example, in the vicinity of the luggage compartment door in the passenger compartment, and are disposed so as to be operated from the luggage compartment door side (i.e., from a vehicle rear side) by opening the luggage compartment door.

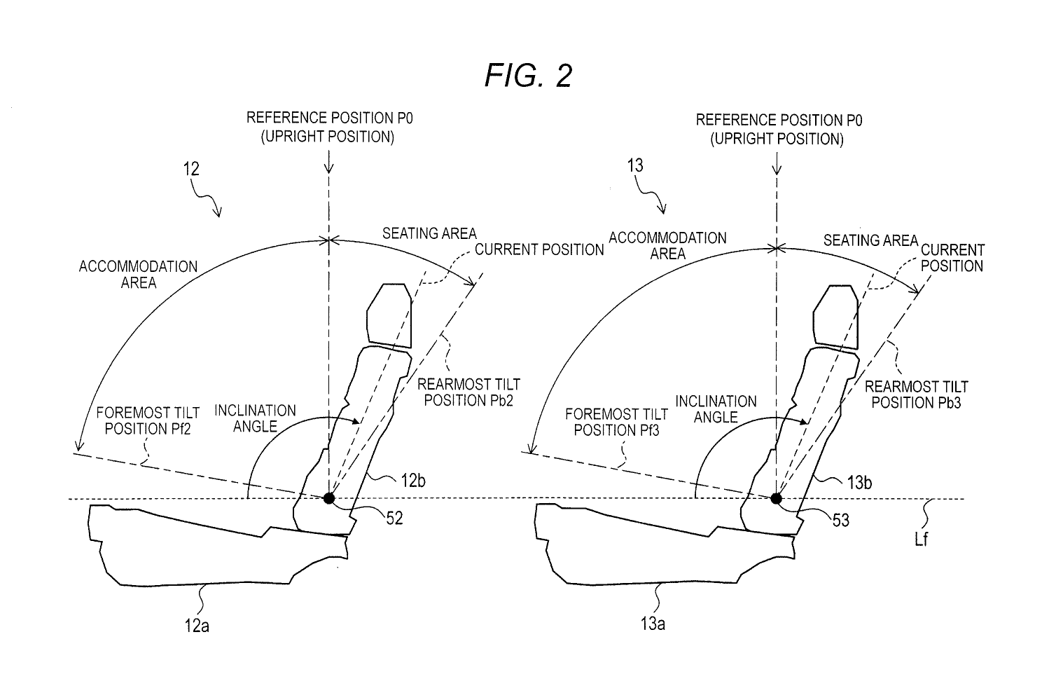

Here, a range in which the second seat back 12b and the third seat back 13b can be rotated will be described more specifically with reference to FIG. 2. As shown in FIG. 2, the second seat back 12b can be rotated within a rotatable range from a foremost tilt position Pf2 to a rearmost tilt position Pb2. The foremost tilt position Pf2 refers to a position when the second seat back 12b is tilted to the foremost side, and the rearmost tilt position Pb2 refers to a position when the second seat back 12b is tilted to the rearmost side.

Here, an angle in a rotating direction of the second seat back 12b toward the rear side with respect to a reference plane Lf parallel to a floor surface of the vehicle 1 is referred to as an inclination angle. The inclination angle is smallest when the second seat back 12b is positioned at the foremost tilt position Pf2. Further, the inclination angle is increased as the second seat back 12b is rotated rearward from the foremost tilt position Pf2. The inclination angle is largest when the second seat back 12b is positioned at the rearmost tilt position Pb2.

The inclination angle of the second seat back 12b can be electrically changed by the second reclining motor 21 as described above. In particular, in a seating area from a predetermined reference position P0 to the rearmost tilt position Pb2 in the rotatable range, a user can continuously or stepwise change the inclination angle of the second seat back 12b by operating a reclining switch (not shown).

Meanwhile, the reference position P0 in the present embodiment refers to an upright position, i.e., a position in which the second seat back 12b is vertically erected with respect to the reference plane Lf. Further, a range from the foremost tilt position Pf2 to the reference position P0 in the rotatable range is referred to as an accommodation area.

When the second seat back 12b is tilted forward to the foremost tilt position Pf2 (i.e., when the second seat back 12b is accommodated), the second seat 12 is in a state (hereinafter, referred to as a “table state”) where the rear surface of the second seat back 12b is close to parallel to the reference plane Lf. Thus, the rear surface of the second seat back 12b can be used as a table.

The rotatable range and position of the third seat back 13b are also basically the same as those of the second seat back 12b. That is, the third seat back 13b can be rotated within a rotatable range from a foremost tilt position Pf3 to a rearmost tilt position Pb3. Further, an inclination angle of the third seat back 13b can be electrically changed by the third reclining motor 31 as described above. Meanwhile, similar to the second seat back 12b, the third seat back 13b may be configured such that, in a seating area, a user can change continuously or stepwise the inclination angle by operating a reclining switch (not shown). When the third seat back 13b is tilted forward to the foremost tilt position Pf3 (i.e., when the third seat back 13b is accommodated), the third seat 13 is in a state where the rear surface of the third seat back 13b is close to parallel to the reference plane Lf.

Meanwhile, in the present embodiment, the inclination angle of the second seat 12 in the foremost tilt position Pf2 is the same as that of the third seat 13 in the foremost tilt position Pf3. However, both inclination angles may be different from each other. Further, in the present embodiment, the inclination angle of the second seat 12 in the rearmost tilt position Pb2 is also the same as that of the third seat 13 in the rearmost tilt position Pb3. However, both inclination angles may be different from each other. Further, in the present embodiment, for both the second seat 12 and the third seat 13, the reference position P0 is set as the same upright position. However, this is just an example. The reference position P0 may be properly determined in an arbitrary setting manner. Further, it is not essential that the reference position of the second seat 12 is the same as that of the third seat 13.

When, among the four switches 23, 24, 33, 34 shown in FIG. 1, the first simultaneously accommodating switch 23 or the second simultaneously accommodating switch 33 is turned on, the second seat back 12b and the third seat back 13b are simultaneously rotated forward, so that both of them reach the foremost tilt position (table state) and are accommodated, as will be described later.

(2) Description of Seat Adjustment Device

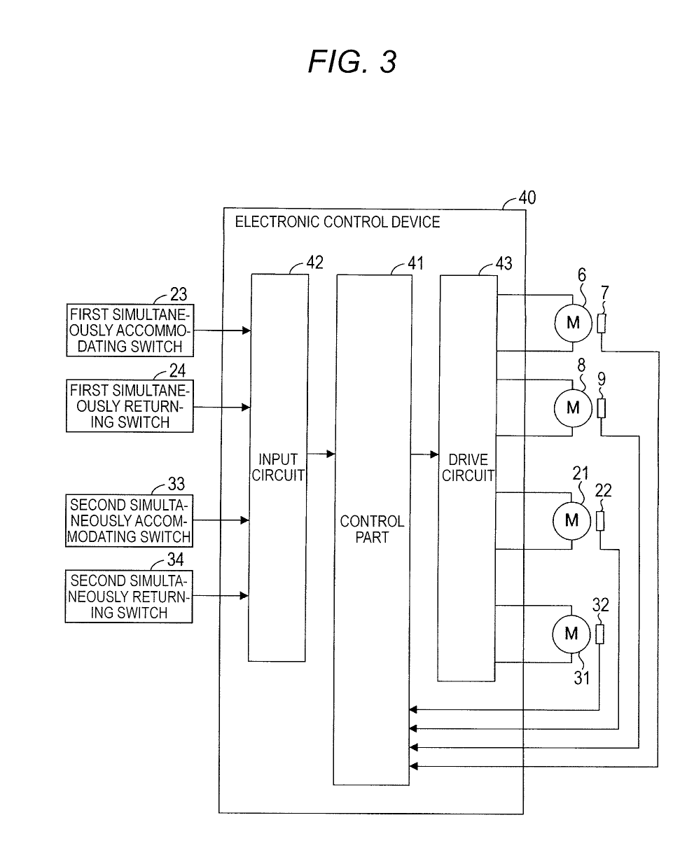

Subsequently, a seat adjustment device provided in the vehicle 1 in order to adjust a position and state of each seat 11, 12, 13 will be described with reference to FIG. 3. As shown in FIG. 3, a seat adjustment device according to the present embodiment includes an electronic control device 10, the four switches 23, 24, 33, 34 described above, and the motors 6, 8, 21, 31 described above.

The four switches 23, 24, 33, 34 are, for example, push-button type switches. These switches are turned on when an operation by a user is performed and are turned off when the operation by a user is released. However, it is not essential that these switches are push-button type switches, but other types of switches may be used.

In the present embodiment, the four motors 6, 8, 21, 31 are, for example, DC motors with brushes. However, it is not essential that these motors are DC motors with brushes, but other types of motors (e.g., brushless motors or stepping motors, etc.) may be used.

The electronic control device 40 includes a control unit 41, an input circuit 42, and a drive circuit 43. The four switches 23, 24, 33, 34 described above and other switches (not shown) are connected to the input circuit 42, to which signals from these switches are respectively inputted. The input circuit 42 outputs the input signal from each switch to the control unit 41 as it is or after appropriately converting the input signal (e.g., subjected to level conversion, AD conversion, impedance conversion, etc.).

The control unit 41 is mainly composed of a well-known microcomputer including a CPU, a memory, and the like. Various functions of the control unit 41 are implemented by the CPU executing a program stored in the memory. Meanwhile, the implementation of the various functions by the control unit 41 is not limited to software, but a part or all of the various functions may be implemented by using hardware in which logic circuits and analog circuits, etc., are combined.

The control unit 41 determines an operation state of each switch based on a signal inputted from each switch via the input circuit 42. Further, in a case where any one of respective switches is operated, the control unit 41 outputs, to the drive circuit 43, a drive signal for driving one or two or more of the four motors 6, 8, 21, 31 described above and other motors (not shown), which correspond to the operated switch.

Further, the drive circuit 43 is configured to individually drive each motor in accordance with the drive signal from the control unit 41. In the drive circuit 43, a driving circuit (e.g., H-bridge circuit) for individually driving each motor is provided for each motor.

Further, among the motors, at least the four motors 6, 8, 21, 31 shown in FIG. 3 are provided with rotation sensors 7, 9, 22, 32, respectively. Each of these rotation sensors 7, 9, 22, 32 is connected to the control unit 41 in the electronic control device 40. A rotation signal that is a signal indicating a rotation position of the corresponding motor is outputted from each of these rotation sensors 7, 9, 22, 32.

The control unit 41 detects a rotation position of the front reclining motor 6 based on the input signal from the rotation sensor 7 provided in the front reclining motor 6 and detects a position (inclination angle) of the front seat back 11b based on the detected rotation position. Further, the control unit 41 detects a rotation position of the slide motor 8 based on the input signal from the rotation sensor 9 provided in the slide motor 8 and detects a position of the front seat 11 in the front and rear direction based on the detected rotation position.

Further, the control unit 41 detects a rotation position of the second reclining motor 21 based on the input signal from the rotation sensor 22 provided in the second reclining motor 21 and detects a position (inclination angle) of the second seat back 12b based on the detected rotation position. Further, the control unit 41 detects a rotation position of the third reclining motor 31 based on the input signal from the rotation sensor 32 provided in the third reclining motor 31 and detects a position (inclination angle) of the third seat back 13b based on the detected rotation position.

Here, one of main features of the disclosure is that the second seat back 12b and the third seat back 13b can be simultaneously accommodated. Accordingly, in the following description, especially by referring to the second seat 12 and the third seat 13 of the three rows of seats, the operation (especially, operation of respective seat backs 12b, 13b) of these two seats 12, 13 will be described. Meanwhile, in the following description, it is assumed that when simply referred to as the “simultaneously accommodating switch,” this means either one of the first simultaneously accommodating switch 23 and the second simultaneously accommodating switch 33.

When the simultaneously accommodating switch is turned on by a user, the electronic control device 40 drives and controls the second reclining motor 21 and the third reclining motor 31 during the turn on (i.e., while a pushing operation is performed), so that the second seat back 12b and the third seat back 13b are respectively rotated to the foremost tilt position and accommodated. Meanwhile, when the simultaneously accommodating switch is once turned on, respective seat backs 12b, 13b may be rotated to the foremost tilt position even when the simultaneously accommodating switch is turned off thereafter.

More specifically, the control unit 41 in the present embodiment controls the operation (directly, the operation of the second reclining motor 21 and the third reclining motor 31) of respective seat backs 12b, 13b as follows in a case where the simultaneously accommodating switch is turned on.

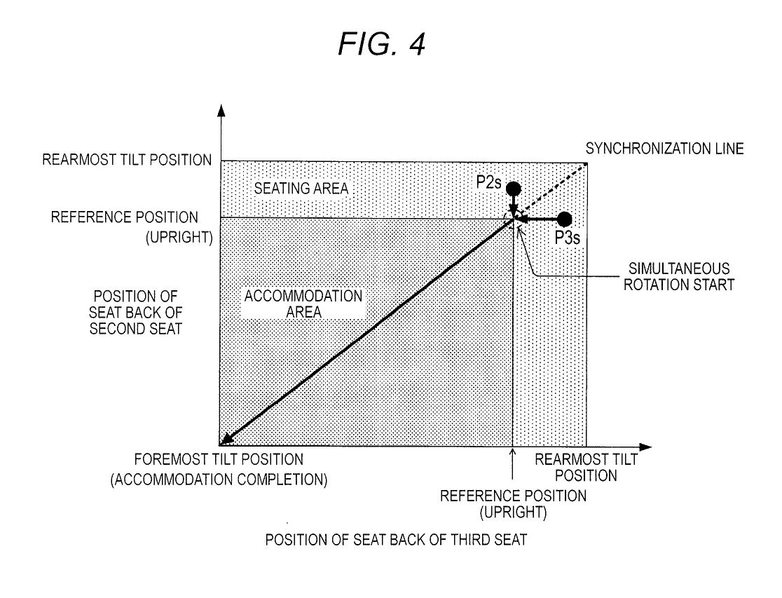

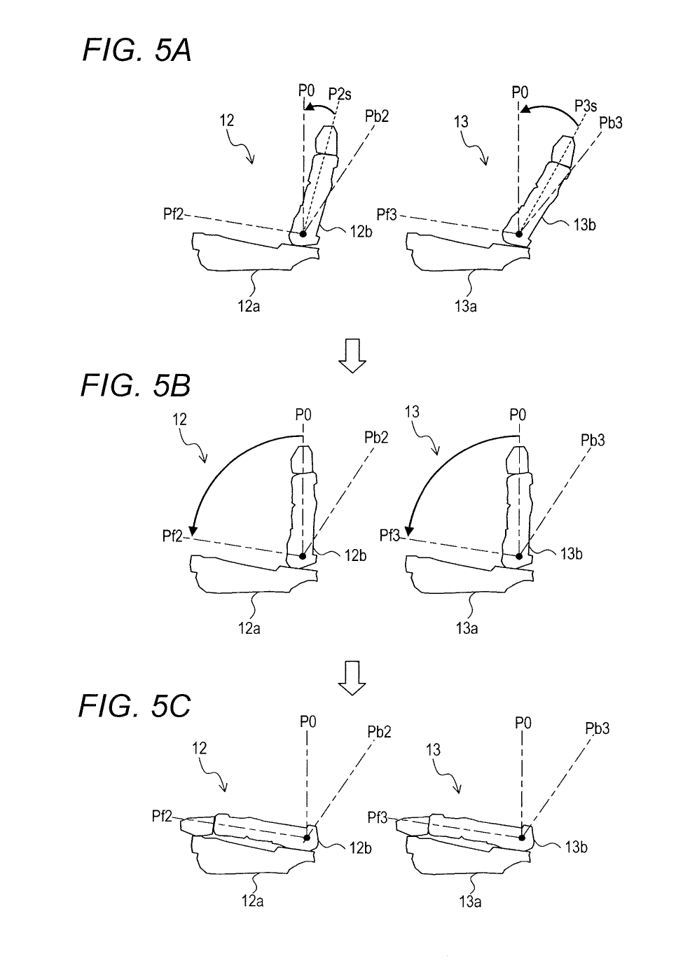

For example, it is assumed that the second seat back 12b is positioned at an initial position P2s in the seating area and the third seat back 13b is positioned at an initial position P3s in the seating area, as shown in FIGS. 4 and 5A.

When the simultaneously accommodating switch is turned on in this state, both seat backs 12b, 13b are simultaneously rotated forward, as indicated by arrows extending from respective initial positions P2s, P3s in FIGS. 4 and 5A. Then, when either one of the seat backs 12b, 13b first reaches a reference position P0, one seat back that has reached earlier is temporarily stopped at the reference position P0. Then, the one seat back waits for the other seat back to reach the reference position P0.

When the other seat back also reaches the reference position P0, and thus, both seat backs 12b, 13b are positioned at the reference position P0 as shown in FIG. 5B, the forward rotating of the respective seat backs 12b, 13b starts in conjunction with each other, as shown in FIG. 4. That is, the seat backs 12b, 13b are simultaneously rotated forward together.

Here, when the other seat back reaches the reference position P0, the process continuously proceeds to simultaneous accommodation of both seat backs 12b. 13b (that is, without stopping the other seat back). However, at the time when the positions of both seat backs 12b, 13b are aligned, the rotating of both seat backs may be temporarily stopped and it may wait for a certain period (e.g., about one second). Then, both seat backs 12b, 13b may be simultaneously rotated forward.

Then, when the seat backs 12b, 13b respectively reach the foremost tilt position and the accommodation thereof is completed, the forward rotating of the seat backs 12b, 13b is stopped. FIG. 5C shows a state in which both seat backs 12b, 13b are tilted forward to the foremost tilt position.

When the respective seat backs 12b, 13b are simultaneously rotated forward from the reference position P0, the control unit 41 of the electronic control device 40 controls an angular velocity of both seat backs so that the respective seat backs 12b, 13b are rotated at a same angular velocity.

The control unit 41 can detect the rotation speed of each motor 21, 31 based on each rotation signal from the rotation sensor 22 provided in the second reclining motor 21 and the rotation sensor 32 provided in the third reclining motor 31. Further, a reduction gear ratio of a transmission mechanism for transmitting the rotation of the second reclining motor 21 to the second seat back 12b and a reduction gear ratio of a transmission mechanism for transmitting the rotation of the third reclining motor 31 to the third seat back 13b are previously known. Therefore, the control unit 41 can obtain the angular velocity of the second seat back 12b and the third seat back 13b by calculation, based on each rotation signal from each rotation sensor 22, 32.

Thus, when the seat backs 12b, 13b are simultaneously rotated forward from the reference position P0, the control unit 41 in the present embodiment controls the speed of each reclining motor 21, 31 so that both seat backs 12b, 13b have the same angular velocity, based on each rotation signal from each rotation sensor 22, 32.

As a specific method of speed control for rotating the two seat backs 12b, 13b at the same angular velocity, a well-known speed control method can be appropriately used. For example, one of the seat backs is not to be controlled and the reclining motor for rotating the one seat back is rotated by supplying a constant current thereto. Then, the reclining motor for rotating the other seat back may be controlled so that the rotating angular velocity of the other seat back follows the rotating angular velocity of the one seat back.

Further, for example, a constant target angular velocity is set, and respective reclining motors 21, 31 may be correspondingly controlled so that the angular velocities of respective seat backs 12b, 13b coincide with the target angular velocity.

In the case where the simultaneously accommodating switch is turned on in the state where either one of the initial positions P2s, P3s of the respective seat backs 12b, 13b is already the reference position P0, the seat back already positioned at the reference position P0 is not rotated and only the other seat back is rotated forward. Then, when the other seat back reaches the reference position P0, the forward rotating of the respective seat backs 12b, 13b starts simultaneously the same manner as described above.

Further, in the case where the simultaneously accommodating switch is turned on in the state where both of the initial positions P2s, P3s of the respective seat backs 12b, 13b are the reference position P0, the forward rotating of the respective seat backs 12b, 13b starts simultaneously.

Further, a control method when at least one of the initial positions P2s, P3s of the respective seat backs 12b, 13b is positioned in the accommodation area may be determined as appropriate. For example, first, both seat backs 12b, 13b may be rotated to the reference position P0, and then, the respective seat backs 12b, 13b may be simultaneously rotated forward from the reference position P0 in the same manner as described above. Further, for example, as in a second embodiment to be described later, first, one of the seat backs 12b, 13b having a smaller inclination angle is stopped. In this state, the seat back having a larger inclination angle is allowed to catch up with the seat back having the smaller inclination angle. When the seat back having the larger inclination angle catches up with the seat back having the smaller inclination angle (when the positions of both seat backs are aligned), both of the seat backs 12b, 13b may be simultaneously rotated forward.

When the respective seat backs 12b, 13b are accommodated as shown in FIG. 5C, and then, either one of the first simultaneously returning switch 24 and the second simultaneously returning switch 34 is turned on, during the period when the first simultaneously returning switch 24 and the second simultaneously returning switch 34 are turned on, the electronic control device 40 drives and controls the second reclining motor 21 and the third reclining motor 31, so that the second seat back 12b and the third seat back 13b are respectively rotated to predetermined return positions in the seating area. In the present embodiment, the rotating to the return position is also performed by both of the seat backs 12b, 13b being simultaneously rotated rearward.

Meanwhile, in the present embodiment, the return position is the reference position P0 (i.e., upright position). However, this is just an example, and an arbitrary position in the seating area may be set as the return position. For example, an original position before being accommodated may be set as the return position. Further, when any one of the simultaneously returning switches is once turned on, the respective seat backs 12b, 13b may be rotated to the return position even when the simultaneously returning switch is turned off thereafter.

(3) Simultaneous Control Processing

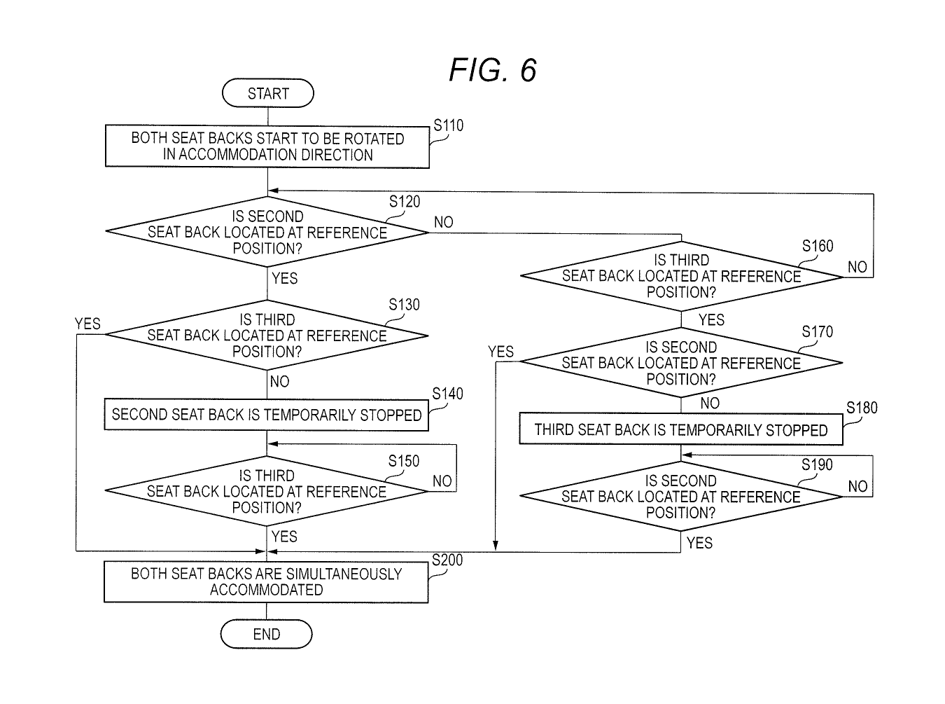

Subsequently, a simultaneous control processing which is executed by the control unit 41 so as to realize the operations of the second seat back 12b and the third seat back 13b described with reference to FIGS. 4 and 5 will be described with reference to FIG. 6. A program of the simultaneous control processing shown in FIG. 6 is stored in the memory of the control unit 41. When the simultaneously accommodating switch is turned on, the CPU of the control unit 41 reads and executes the program of the simultaneous control processing shown in FIG. 6 from the memory.

As the simultaneous control processing shown in FIG. 6 is started, in step S110, the CPU of the control unit 41 starts to rotate both seat backs (the second seat back 12b and the third seat back 13b) in the accommodation direction. Specifically, the CPU of the control unit 41 drives the second reclining motor 21 and the third reclining motor 31 to rotate both seat backs forward. Meanwhile, in a case where there is a seat back already located at the reference position, this seat back is not rotated in step S110 and is kept on stand-by as it is.

In step S120, it is determined whether or not the second seat back 12b is positioned at the reference position P0. In a case where it is determined that the second seat back 12b is not yet positioned at the reference position P0 but located on the rear side of the reference position P0, the process proceeds to step S160.

In step S160, it is determined whether or not the third seat back 13b is positioned at the reference position P0. In a case where it is determined that the third seat back 13b is not yet positioned at the reference position P0 but located on the rear side of the reference position P0, the process returns to step S120.

In a case where it is determined in step S120 that the second seat back 12b is positioned at the reference position P0, the process proceeds to step S130. Similar to step S160, in step S130, it is determined whether or not the third seat back 13b is positioned at the reference position P0. In a case where it is determined that the third seat back 13b is positioned at the reference position P0, the process proceeds to step S200.

In step S200, the simultaneous accommodating of both seat backs 12b, 13b are performed. That is, as described with reference to FIGS. 5B and 5C, both seat backs 12b, 13b are simultaneously rotated forward and thus reach the foremost tilt position. Then, when the seat backs reach the foremost tilt position, the forward rotating thereof is stopped. When both seat backs reach the foremost tilt position and thus the rotating thereof is stopped, the simultaneous control processing is ended.

In a case where it is determined in step S130 that the third seat back 13b is not yet positioned at the reference position P0 but located on the rear side of the reference position P0, the process proceeds to step S140. In step S140, the forward rotating of the second seat back 12b is temporarily stopped.

In step S150, it is determined whether or not the third seat back 13b is positioned at the reference position P0. The determination in step S150 is repeated until the third seat back 13b reaches the reference position P0. Then, when the third seat back 13b reaches the reference position P0, the process proceeds to step S200 and the simultaneous accommodating of both seat backs 12b, 13b are performed.

In a case where it is determined in step S160 that the third seat back 13b is positioned at the reference position P0, the process proceeds to step S170. In step S170, it is determined whether or not the second seat back 12b is positioned at the reference position P0. In a case where it is determined that the second seat back 12b is positioned at the reference position P0, the process proceeds to step S200 and the simultaneous accommodating of both seat backs 12b, 13b are performed.

In a case where it is determined in step S170 that the second seat back 12b is not yet positioned at the reference position P0 but located on the rear side of the reference position P0, the process proceeds to step S180. In step S180, the forward rotating of the third seat back 13b is temporarily stopped.

In step S190, it is determined whether or not the second seat back 12b is positioned at the reference position P0. The determination in step S190 is repeated until the second seat back 12b reaches the reference position P0. Then, when the second seat back 12b reaches the reference position P0, the process proceeds to step S200 and the simultaneous accommodating of both seat backs 12b, 13b are performed.

(4) Effect of First Embodiment

According to the first embodiment described above, the following effects can be obtained.

That is, in a case where the second seat back 12b and the third seat back 13b are positioned in the seating area, both seat backs 12b, 13b can be shifted together to the accommodation state (i.e., can be rotated to the foremost tilt position) by a user turning on the simultaneously accommodating switch.

In addition, in the course of shifting the second seat 12 and the third seat 13 to the accommodation state, there is a period during which the respective seat backs 12b, 13b of these seats 12, 13 are simultaneously and rotated forward. Therefore, both seats 12, 13 can be shifted to the accommodation state in a short time.

Therefore, according to the first embodiment, in the three-row seat type vehicle 1, it is possible to improve the usability of a user when both the second seat back 12b and the third seat back 13b are tilted forward.

Further, in the present embodiment, in a case where the simultaneously accommodating switch is turned on, first, both the second seat back 12b and the third seat back 13b are controlled to be positioned at the reference position P0. Then, when both seat backs 12b, 13b are aligned in the reference position P0, the simultaneous accommodating is started and both seat backs are simultaneously rotated to the foremost tilt position. Therefore, both seats 12, 13 can be shifted to the accommodation state in a shorter time and more efficiently. Furthermore, since both seat backs 12b, 13b are simultaneously accommodated after both seat backs 12b, 13b are aligned in the reference position P0, a luxurious feeling is rendered, which makes it possible for a user to feel satisfaction.

Furthermore, in the present embodiment, the reclining motors 21, 31 are controlled such that both seat backs 12b, 13b are rotated forward at the same angular velocity when the seat backs are simultaneously accommodated from the reference position P0. Therefore, it is possible to further enhance the effect of luxurious feeling when both seat backs 12b, 13b are simultaneously accommodated.

(5) Correspondence with Claims

Here, the correspondence between the terms in the present embodiment and the terms in the claims will be described.

The second seat 12 corresponds to the second-to-last-row seat, and the third seat 13 corresponds to the last-row seat. The second reclining motor 21 corresponds to the second drive part, and the third reclining motor 31 corresponds to the first drive part. Both the first simultaneously accommodating switch 23 and the second simultaneously accommodating switch 33 correspond to the operation part. The control unit 41 corresponds to the accommodation control part. The rotation sensor 22 provided in the second reclining motor 21 corresponds to the second detection part, and the rotation sensor 32 provided in the third reclining motor 31 corresponds to the first detection part. Further, the reference position P0 corresponds to the reference angle. In the simultaneous control processing shown in FIG. 6, the processing in steps S110 to S190 corresponds to the initial drive processing, and the processing in step S200 corresponds to the simultaneous drive processing.

### Second Embodiment

A method for the rotation control (in turn, the rotating control of the respective seat backs 12b, 13b) of the respective reclining motors 21, 31 in a case where the simultaneously accommodating switch is turned on will be described as a second embodiment. The control method of the second embodiment is different from the control method of the first embodiment.

In the control method of the first embodiment, in a case where the simultaneously accommodating switch is turned on, both seat backs 12b, 13b are first aligned in the reference position P0 and are simultaneously accommodated from the reference position P0. On the other hand, in the second embodiment, first, one of the seat backs 12b, 13b having a smaller inclination angle (i.e., the seat back located further toward the foremost tilt position side) is used as a reference for the start of simultaneous accommodation, and only the seat back having a larger inclination angle is rotated forward and aligned at the same position (the same inclination angle) as the seat back having the smaller inclination angle. Then, when the positions of both seat backs 12b, 13b are aligned, the simultaneous accommodating is started.

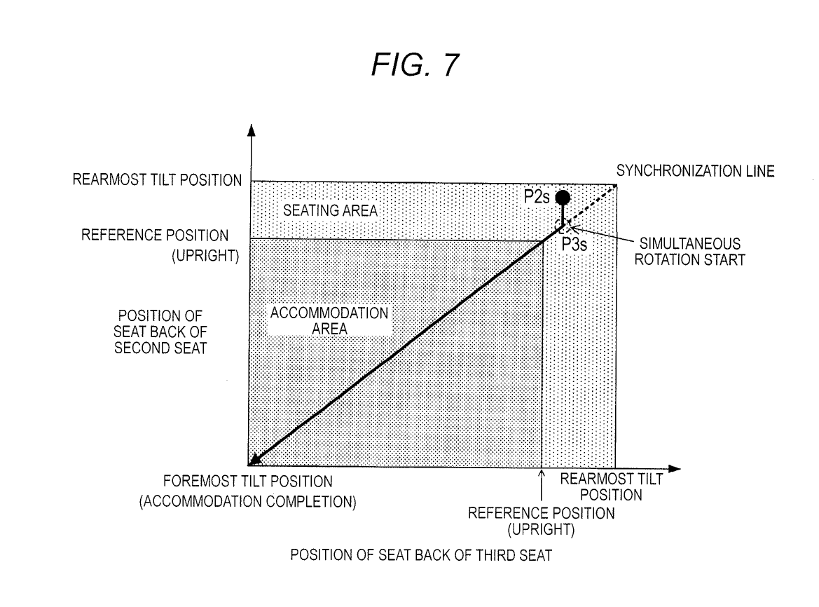

For example, as shown in FIG. 7, it is assumed that the initial position P2s of the second seat back 12b has a larger inclination angle than the initial position P3s of the third seat back 13b, and thus, the second seat back 12b is located more rearward than the third seat back. When the simultaneously accommodating switch is turned on in this state, the third seat back 13b having the smaller inclination angle is not rotated, but only the second seat back 12b is rotated forward.

Then, when the second seat back 12b reaches the initial position P3s of the third seat back 13b and thus the positions of both seat backs 12b, 13b are aligned, both seat backs 12b, 13b are started to be simultaneously rotated forward.

Meanwhile, when the second seat back 12b reaches the initial position P3s of the third seat back 13b, the process continuously shifts to simultaneous accommodation of both seat backs 12b, 13b (that is, without stopping the second seat back 12b). However, at the time when the positions of both seat backs 12b, 13b are aligned, the rotating of both seat backs may be temporarily stopped and it may wait for a certain period (e.g., about one second). Then, both seat backs 12b, 13b may be simultaneously rotated forward.

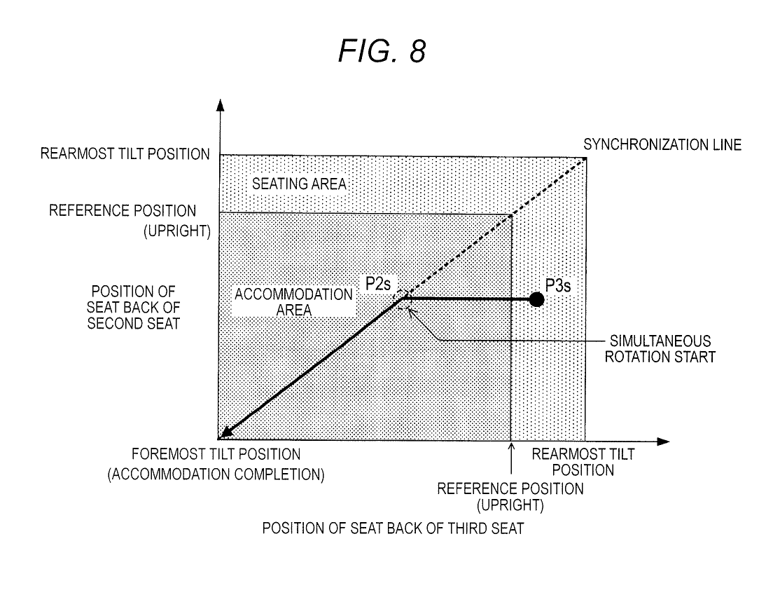

This is similarly applied to the case where the initial position of the seat back having a smaller inclination angle is located in an accommodation area. That is, for example, as shown in FIG. 8, it is assumed that the initial position P2s of the second seat back 12b is located on the front side of the initial position P3s of the third seat back 13b and the initial position P2s of the second seat back 12b is positioned in the accommodation area. When the simultaneously accommodating switch is turned on in this state, the second seat back 12b having the smaller inclination angle is not rotated, but only the third seat back 13b is first rotated forward.

Then, when the third seat back 13b reaches the initial position P2s of the second seat back 12b in the accommodation area and thus the positions of both seat backs 12b, 13b are aligned, both seat backs 12b, 13b are started to be simultaneously rotated forward.

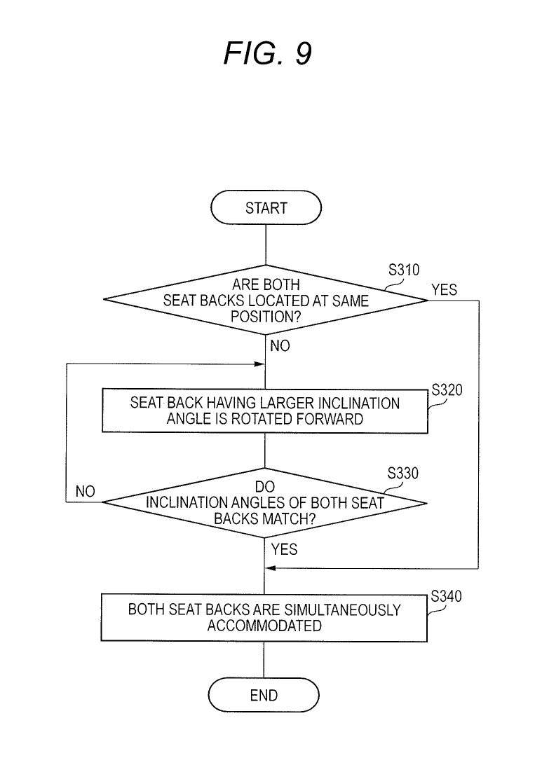

The simultaneous control processing of the second embodiment to be performed by the control unit 41 so as to realize the control exemplified in FIGS. 7 and 8 will be described with reference to FIG. 9. When the simultaneous control processing shown in FIG. 9 is started, in step S310, the CPU of the control unit 41 determines whether or not both seat backs 12b, 13b are located at the same position (i.e., have the same inclination angle). In a case where it is determined that both seat backs 12b, 13b are already located at the same position, in step S340, the simultaneous accommodating of both seat backs 12b, 13b is performed. The processing in step S340 is the same as the processing in step S200 of FIG. 6.

In a case where it is determined in step S310 that both seat backs 12b, 13b are not located at the same position, the process proceeds to step S320. In step S320, one of both seat backs 12b, 13b having a larger inclination angle is rotated forward.

In step S330, it is determined whether or not the inclination angles of both seat backs 12b, 13b match. In a case where it is determined that the inclination angles do not match yet, the process returns to step S320 and the forward rotating of the seat back having a larger inclination angle continues. In a case where it is determined that the inclination angles of both seat backs 12b, 13b match, the process proceeds to step S340 and the simultaneous accommodating of both seat backs 12b, 13b is performed.

According to the second embodiment described above, the same effects as the first embodiment are also obtained. Especially, in the second embodiment, in a case where the simultaneously accommodating switch is turned on, first, one of the second seat back 12b and the third seat 13b having a smaller inclination angle is used as a reference, and only the seat back having a larger inclination angle is rotated forward. Therefore, the positions of the seat backs 12b, 13b can be more effectively aligned, and the seats 12, 13 can be more effectively shifted to the accommodation state.

### Other Embodiments

Although the embodiments of the disclosure have been described above, the disclosure is not limited the above-described embodiments, and various modifications can be made.

(1) As soon as the simultaneously accommodating switch is turned on, both seat backs 12b, 13b may be simultaneously rotated forward together and reach the foremost tilt position, respectively. At that time, each of the seat backs 12b, 13b may be rotated at different angular velocities or may be rotated at a same angular velocity.

Alternatively, in the early stage of rotating, both seat backs may be rotated together and the seat back having a larger inclination angle may be rotated at a higher speed than the seat back having a smaller inclination angle. In this way, the seat back having the larger inclination angle is allowed to gradually catch up with the seat back having the smaller inclination angle. When the seat back having the larger inclination angle catches up with the seat back having the smaller inclination angle and thus the positions (inclination angles) of both seat backs are aligned, the process may be switched to a same angular velocity control.

(2) Both seat backs 12b, 13b may be sequentially accommodated with a time difference therebetween. For example, first, only the third seat back 13b may start to be rotated forward, and then, the second seat back 12b may also start to be rotated after a predetermined time has elapsed (i.e., after the third seat back is rotated by a predetermined angle). After that, both seat backs may be simultaneously rotated.

(3) In each of the above embodiments, one electronic control device 40 is configured to control the second reclining motor 21 and the third reclining motor 31. However, such a hardware configuration is just an example.

For example, an electronic control device for the second seat 12 and an electronic control device for the third seat 13 are respectively provided. Further, the electronic control device for the second seat 12 may control the second reclining motor 21, and the electronic control device for the third seat 13 may control the third reclining motor 31. Further, both electronic control devices may be connected to each other by a wired or wireless data communication network so as to enable data communication. Control information on own device side is transmitted to the other side to share information with each other. As a result, the simultaneous control processing (see FIGS. 6 and 9) described in each of the above embodiments may be implemented.

(4) The vehicle seat adjustment device of the disclosure may be mounted on another vehicle other than the three-row seat type vehicle.

For example, the vehicle seat adjustment device may be mounted on a two-row seat type vehicle so as to adjust the states of a second seat in a last row (i.e., in a second row from the front) and a front seat in a second-to-last row (i.e., in a first row from the front). In the two-row seat type vehicle, a space in a passenger compartment is narrower than that in a vehicle with three or more rows of seats, and thus, it is difficult to effectively utilize the space in the passenger compartment. However, when the vehicle seat adjustment device of the disclosure is mounted on such a vehicle, two rows of seats aligned in the front and rear direction can be accommodated by an electrical power, and thus, it is possible to effectively utilize the narrow passenger compartment to the maximum.

Further, for example, even for a vehicle with four or more rows of seats, the vehicle seat adjustment device of the disclosure may be mounted to adjust respective seats in the last row and the second-to-last row.

(5) In addition, the functions of one component in the above embodiments may be distributed to a plurality of components or the functions of a plurality of components may be incorporated into one component. Further, a part of the configurations of the above embodiments may be omitted. Further, at least a part of the configurations of the above embodiments may be added to or replaced with the configurations of the other embodiment described above. Meanwhile, all aspects included within the technical concept specified only by the terms described in the claims are embodiments of the disclosure.

The disclosure provides illustrative, non-limiting examples as follows:

According to an aspect of the disclosure, there is provided a vehicle seat adjustment device mounted on a vehicle in which a plurality of seats including a last-row seat in a last row and a second-to-last-row seat in a second-to-last row is arranged in a front and rear direction and configured to adjust states of the last-row seat and the second-to-last-row seat, the vehicle seat adjustment device including: a first drive part configured to rotate a seat back of the last-row seat relative to a seat cushion of the last-row seat; a second drive part configured to rotate a seat back of the second-to-last-row seat relative to a seat cushion of the second-to-last-row seat; an operation part configured to be operated by a user; and an accommodation control part configured to, in a case where the operation part is operated, shift the last-row seat to an accommodation state in which the seat back of the last-row seat is rotated forward and folded down by driving the first drive part to thus rotate the seat back of the last-row seat forward, and shift the second-to-last-row seat to an accommodation state in which the seat back of the second-to-last-row seat is rotated forward and folded down by driving the second drive part to thus rotate the seat back of the second-to-last-row seat forward, wherein, when respectively shifting the last-row seat and the second-to-last-row seat to their accommodation states by operating the operation part, the accommodation control part is configured to control the first drive part and the second drive part so that there is a period during which the seat back of the last-row seat and the seat back of the second-to-last-row seat are simultaneously rotated forward.

According to the vehicle seat adjustment device having such a configuration, both the last-row seat and the second-to-last-row seat can be shifted to their accommodation states by a user operating the operation part. In addition, in the course of shifting the last-row seat and the second-to-last-row seat to their accommodation states, there is a period during which the seat back of the last-row seat and the seat back of the second-to-last-row seat are simultaneously rotated forward. Therefore, it is possible to shorten the time required for shifting both seats to their accommodation states, as compared with a method of sequentially shifting the last-row seat and the second-to-last-row seat to their accommodation states, i.e., the method of first shifting only one of the last-row seat and the second-to-last-row seat to the accommodation state, and then, shifting the other of the last-row seat and the second-to-last-row seat to the accommodation state, for example.

Thus, according to the vehicle seat adjustment device having such a configuration, it is possible to improve the usability of a user when tilting, toward the front, both of the seat backs of the respective seats in the last row and the second-to-last row in the vehicle in which a plurality of seats is arranged in the front and rear direction.

The above-described vehicle seat adjustment device may further include a first detection part configured to detect information representing an inclination angle of the seat back of the last-row seat, which is an angle in a rearward rotating direction of the seat back of the last-row seat with respect to a specific reference plane, and a second detection part configured to detect information representing an inclination angle of the seat back of the second-to-last-row seat, which is an angle in a rearward rotating direction of the seat back of the second-to-last-row seat with respect to the specific reference plane. The accommodation control part may be configured to perform: an initial drive processing of causing the inclination angle of the seat back of the last-row seat and the inclination angle of the seat back of the second-to-last-row seat to match a reference angle by rotating at least the seat back whose inclination angle is larger among the seat back of the last-row seat and the seat back of the second-to-last-row seat forward based on the detection results by the first detection part and the second detection part, in a case where the operation part is operated; and a simultaneous drive processing of shifting the last-row seat and the second-to-last-row seat to the accommodation state, respectively, by simultaneously rotating the seat back of the last-row seat and the seat back of the second-to-last-row seat forward after the inclination angle of the seat back of the last-row seat and the inclination angle of the seat back of the second-to-last-row seat has matched the reference angle by the initial drive processing.

According to the vehicle seat adjustment device having such a configuration, the last-row seat and the second-to-last-row seat are shifted to the accommodation state, respectively, by simultaneously rotating the seat back of the last-row seat and the seat back of the second-to-last-row seat forward after the inclination angle of the seat back of the last-row seat and the inclination angle of the seat back of the second-to-last-row seat has matched the reference angle. Therefore, it is possible to shift both seats to the accommodation state in a shorter time.

In addition, first, the inclination angles of the seat back of the last-row seat and the seat back of the second-to-last-row seat are aligned to the reference angle by the initial drive processing, and then, the seat back of the last-row seat and the seat back of the second-to-last-row seat are simultaneously rotated forward from the state in which the inclination angles of the seat back of the last-row seat and the seat back of the second-to-last-row seat are aligned to the reference angle. Therefore, as a whole, both seats are simultaneously accommodated in a state of being aligned, so that it is possible to produce a luxurious feeling when shifting the last-row seat and the second-to-last-row seat to their accommodation states.

In the above-described vehicle seat adjustment device, in the initial drive processing, the accommodation control part may simultaneously start the forward rotating of the seat back of the last-row seat and the seat back of the second-to-last-row seat for causing the inclination angle of the seat back of the last-row seat and the inclination angle of the seat back of the second-to-last-row seat to match the reference angle, and in a case where the inclination angle of one of the seat backs reaches the reference angle earlier than the inclination angle of another of the seat backs, the accommodation control part may stop the rotating of the one of the seat backs until the inclination angle of the other of the seat backs reaches the reference angle.

By performing the initial drive processing as described above, the inclination angles of the seat back of the last-row seat and the seat back of the second-to-last-row seat can be effectively aligned to the reference angle even when the inclination angles of the seat back of the last-row seat and the seat back of the second-to-last-row seat are different from each other. Therefore, as a whole, it is possible to effectively shift the last-row seat and the second-to-last-row seat to the accommodation state.

In the above-described vehicle seat adjustment device, the reference angle may be a smaller one of the inclination angle of the seat back of the last-row seat and the inclination angle of the seat back of the second-to-last-row seat. Further, in the initial drive processing, the accommodation control part may cause the inclination angle of the seat back of the last-row seat and the inclination angle of the seat back of the second-to-last-row seat to match the reference angle by rotating only the seat back whose inclination angle is larger among the seat back of the last-row seat and the seat back of the second-to-last-row seat forward.

By setting the reference angle to be a smaller one of the inclination angle of the seat back of the last-row seat and the inclination angle of the seat back of the second-to-last-row seat in this manner, in the initial drive processing, it is not necessary to rotate the seat back having a smaller inclination angle (i.e., the seat back whose inclination angle already matches the reference angle), and it is sufficient to rotate only the seat back having a larger inclination angle forward. Therefore, the inclination angle of the seat back of the last-row seat and the inclination angle of the seat back of the second-to-last-row seat can be more efficiently aligned to the reference angle, so that it is possible to more effectively shift the last-row seat and the second-to-last-row seat to the accommodation state.

In the above-described vehicle seat adjustment device, in the simultaneous drive processing, the accommodation control part may control the driving of the first drive part and the second drive part so that the seat back of the last-row seat and the seat back of the second-to-last-row seat are rotated forward at a same angular velocity, based on the detection results by the first detection part and the second detection part.

By rotating the respective seat backs at a same angular velocity, it is possible to further enhance the effect of luxurious feeling when the last-row seat and the second-to-last-row seat are shifted to the accommodation state.

In the above-described vehicle seat adjustment device, the vehicle may have three rows of seats arranged in the front and rear direction.

By mounting the vehicle seat adjustment device on a three-row seat type vehicle, it is possible to effectively utilize the space behind the front-row seat and thus to improve the convenience of the three-row seat type vehicle.

According to another aspect of the disclosure, there is provided a vehicle seat adjustment method for a vehicle in which a plurality of seats including a last-row seat in a last row and a second-to-last-row seat in a second-to-last row is arranged in a front and rear direction, the vehicle seat adjustment method including: operating an operation part; and in a case where the operation part is operated, shifting the last-row seat to an accommodation state in which a seat back of the last-row seat is rotated forward and folded down by rotating the seat back of the last-row seat forward, and shifting the second-to-last-row seat to an accommodation state in which a seat back of the second-to-last-row seat is rotated forward and folded down by rotating the seat back of the second-to-last-row seat forward, wherein, when respectively shifting the last-row seat and the second-to-last-row seat to their accommodation states, there is a period during which the seat back of the last-row seat and the seat back of the second-to-last-row seat are simultaneously rotated forward.

What is claimed is:

1. A vehicle seat adjustment device mounted on a vehicle in which a plurality of seats including a last-row seat in a last row and a second-to-last-row seat in a second-to-last row is arranged in a front and rear direction and configured to adjust states of the last-row seat and the second-to-last-row seat, the vehicle seat adjustment device comprising:
a first drive part configured to rotate a seat back of the last-row seat relative to a seat cushion of the last-row seat;
a second drive part configured to rotate a seat back of the second-to-last-row seat relative to a seat cushion of the second-to-last-row seat;
an operation part configured to be operated by a user; and
an accommodation control part configured to, in a case where the operation part is operated, shift the last-row seat to an accommodation state in which the seat back of the last-row seat is rotated forward and folded down by driving the first drive part to thus rotate the seat back of the last-row seat forward, and shift the second-to-last-row seat to an accommodation state in which the seat back of the second-to-last-row seat is rotated forward and folded down by driving the second drive part to thus rotate the seat back of the second-to-last-row seat forward,
wherein, when respectively shifting the last-row seat and the second-to-last-row seat to their accommodation states by operating the operation part, the accommodation control part is configured to control the first drive part and the second drive part so that there is a period during which the seat back of the last-row seat and the seat back of the second-to-last-row seat are simultaneously rotated forward.

2. The vehicle seat adjustment device according to claim 1, further comprising:
a first detection part configured to detect information representing an inclination angle of the seat back of the last-row seat, which is an angle in a rearward rotating direction of the seat back of the last-row seat with respect to a specific reference plane; and
a second detection part configured to detect information representing an inclination angle of the seat back of the second-to-last-row seat, which is an angle in a rearward rotating direction of the seat back of the second-to-last-row seat with respect to the specific reference plane, and
wherein the accommodation control part is configured to perform:
an initial drive processing of causing the inclination angle of the seat back of the last-row seat and the inclination angle of the seat back of the second-to-last-row seat to match a reference angle by rotating at least the seat back whose inclination angle is larger among the seat back of the last-row seat and the seat back of the second-to-last-row seat forward based on the detection results by the first detection part and the second detection part, in a case where the operation part is operated; and
a simultaneous drive processing of shifting the last-row seat and the second-to-last-row seat to the accommodation state, respectively, by simultaneously rotating the seat back of the last-row seat and the seat back of the second-to-last-row seat forward after the inclination angle of the seat back of the last-row seat and the inclination angle of the seat back of the second-to-last-row seat has matched the reference angle by the initial drive processing.

3. The vehicle seat adjustment device according to claim 2,
wherein, in the initial drive processing, the accommodation control part simultaneously starts the forward rotating of the seat back of the last-row seat and the seat back of the second-to-last-row seat for causing the inclination angle of the seat back of the last-row seat and the inclination angle of the seat back of the second-to-last-row seat to match the reference angle, and in a case where the inclination angle of one of the seat backs reaches the reference angle earlier than the inclination angle of another of the seat backs, the accommodation control part stops the rotating of the one of the seat backs until the inclination angle of the other of the seat backs reaches the reference angle.

4. The vehicle seat adjustment device according to claim 2,
wherein the reference angle is a smaller one of the inclination angle of the seat back of the last-row seat and the inclination angle of the seat back of the second-to-last-row seat, and
wherein, in the initial drive processing, the accommodation control part causes the inclination angle of the seat back of the last-row seat and the inclination angle of the seat back of the second-to-last-row seat to match the reference angle by rotating only the seat back whose inclination angle is larger among the seat back of the last-row seat and the seat back of the second-to-last-row seat forward.

5. The vehicle seat adjustment device according to claim 2,
wherein, in the simultaneous drive processing, the accommodation control part controls the driving of the first drive part and the second drive part so that the seat back of the last-row seat and the seat back of the second-to-last-row seat are rotated forward at a same angular velocity, based on the detection results by the first detection part and the second detection part.

6. The vehicle seat adjustment device according to claim 1,
wherein the vehicle has three rows of seats arranged in the front and rear direction.

7. A vehicle seat adjustment method for a vehicle in which a plurality of seats including a last-row seat in a last row and a second-to-last-row seat in a second-to-last row is arranged in a front and rear direction, the vehicle seat adjustment method comprising:
operating an operation part; and
in a case where the operation part is operated, shifting the last-row seat to an accommodation state in which a seat back of the last-row seat is rotated forward and folded down by rotating the seat back of the last-row seat forward, and shifting the second-to-last-row seat to an accommodation state in which a seat back of the second-to-last-row seat is rotated forward and folded down by rotating the seat back of the second-to-last-row seat forward,
wherein, when respectively shifting the last-row seat and the second-to-last-row seat to their accommodation states, there is a period during which the seat back of the last-row seat and the seat back of the second-to-last-row seat are simultaneously rotated forward.
